(19) United States
(12) Patent Application Publication
(10) Pub. No.: US 2026/0108066 A1
(43) Pub. Date: Apr. 23, 2026

(54) A PIECE OF SITTING FURNITURE COMPRISING A BACKREST, A SEAT, AND A FUNCTIONAL UNIT, THE FUNCTIONAL UNIT BEING DESIGNED AND EQUIPPED TO BE ATTACHED TO A BASE, AND A USE OF THE PIECE OF SITTING FURNITURE

(71) Applicant: Sykkylven Stål AS, SYKKYLVEN (NO)

(72) Inventor: Lars Magnus SKOG, Sykkylven (NO)

(21) Appl. No.: 19/154,744

(22) PCT Filed: Oct. 22, 2024
(86) PCT No.: PCT/NO2024/050224

§ 371 Date: Aug. 7, 2025

(30) Foreign Application Priority Data
Oct. 23, 2023 (NO) 20231121

(51) Int. Cl. A47C 1/032; A47C 7/00

(52) U.S. Cl. CPC A47C 1/03294; A47C 7/002

(57) ABSTRACT

A piece of sitting furniture including a backrest, a seat, and a functional unit attached to a base. Each of the backrest, the seat, and the functional unit are provided with at least one hinge element. The functional unit is arranged under the seat and has a sliding bearing including a housing attached to a front of the functional unit forming an acute angle with the main plane of the functional unit. A first bearing is formed between the sliding bearing and a seat element; a first rotational bearing is formed between the seat and backrest, and the second rotational bearing is formed between the functional element and the backrest. The first and second rotational bearing are arranged at the rear of the seat, and the first rotational bearing is arranged under the second rotational bearing. The piece of seating furniture is suitable for small chairs placed next to a table.

### FIELD

The invention concerns a piece of sitting furniture with a movable seat and backrest, as stated in the introduction to Claim 1, and its use as stated in Claim 5.

### BACKGROUND

There are different types of chair mounts that change the seat angle and backrest angle in a chair. Prior art includes NO 339052 B1, which comprises a device in a piece of sitting furniture with a seat device and a backrest device connected via at least one first swivel coupling in the respective connecting parts on the backrest device and the rear part of the seating device. The base is designed to bear the seat device and the backrest device. The backrest device comprises at least one part that goes in the direction of the base and past the first swivel coupling, where at least one part is connected in a swivel manner and supported in the base by at least one respective linking arm. The seat device is connected in a swivel manner and supported in the base by a second swivel coupling, which is arranged closer to the front edge of the seat device than the first swivel coupling. A lockable control device is arranged to regulate the movements between the backrest device and the seat device.

Prior art also includes U.S. Pat. No. 7,806,478 B1, which describes a chair, which can perform synchronized movements forward and backward relative to a base unit, a joint supported by the base unit to pivot about an axis relative to the base unit, a seat unit rotatable in relation to the joint, and a backrest unit rotatable in relation to the coupling. The coupling may be a bracket and an elastic bendable combination held in relation to the bracket. A projection held by the base combination may engage the elastic bendable combination, whereby the joint and the seat and backrest combination may pivot in relation to the base unit.

A simplified mechanism is needed to move the backrest backwards while the seat lifts and changes the seating angle.

### SUMMARY

The invention is stated and characterised in the independent patent claim, while the dependent patent claims indicate other characteristics of the invention.

It presents a piece of furniture comprising a backrest, a seat, and a functional unit, where the functional unit is designed and equipped to be attached to the base, where the piece of furniture is characterised in:
that each of the backrest, the seat, and the functional unit are provided with at least one firmly attached hinge element, and that the functional unit is arranged under the seat and provided with a sliding bearing, which includes a housing firmly attached to a front part of the functional unit and forms an acute angle with the main plane of the functional unit;
a front bearing between the sliding bearing and a seat element;
a first rotational bearing between the seat and the backrest;
a second rotational bearing between the functional element and the backrest;
where the first rotational bearing and the second rotational bearing are arranged at the rear part of the seat, and the first rotational bearing is arranged under the second rotational bearing.

In one embodiment, the backrest hinge element protrudes downwards from a lower part of the backrest, the seat hinge element extends backwards from a rear part of the seat towards the backrest, and the functional hinge element extends backwards from a rear part of the functional element towards the backrest.

In one embodiment, the front bearing is formed by a rotational connection between a connection part of the sliding bearing and the seat element in the seat, and the seat element is preferably placed in the front part of the seat.

In one embodiment
the first rotational bearing is formed by a rotational coupling between the lower bearing part in the backrest hinge element and a bearing part in the seat hinge element, and
the second rotational bearing is formed by a rotational coupling between the upper bearing part in the backrest hinge element and a bearing part in the functional hinge element.

An application of the piece of seating furniture according to the invention is characterised by moving the backrest backwards, upon which the backrest is rotated through the second bearing, and the seat is led forward and slightly upwards through the first bearing, and that at the same time the seat moves up and forward by a sliding tube in the sliding bearing moving in a linear direction to its final stop, and when the person sitting on the chair leans forward, all the weight is shifted to the seat and the sliding tube and the seat move down, and at the same time the first bearing goes down and backwards, and the backrest swings forward through the second bearing.

This invention is a device for use in seating furniture and is intended for dining rooms, office chairs, conferences, and in public transportation. The device makes it possible to change the sitting position by moving the backrest of the chair backwards and forward without using the hands, doing so by moving the body's center of gravity.

The seating furniture according to the invention and the functional unit design and dimensioning constitute a unique, simple and cost-effective mechanism, so that the backrest can be moved backwards while the seat rises and changes the sitting angle. The back moves forward again when the body leans forward, so that the centre of gravity is moved, most of the body weight comes over to the seat, which then pushes the backrest forward to the starting point. Another important aspect is that neither the backrest nor the seat require external suspension points, everything is hidden in the backrest and under the seat, which gives designers the freedom to design the chair according to their wishes.

### BRIEF DESCRIPTION OF THE DRAWINGS

The above and other characteristics of the invention are further described in the embodiment description below as a non-limiting example and with reference to the accompanying drawings, where:

FIG. 1 is a perspective drawing of an embodiment of the seating furniture according to the invention shown with the backrest in a front position;

FIG. 2 corresponds to FIG. 1, but shows the piece of seating furniture from the side;

FIG. 3 is a perspective drawing of the seating furniture shown in FIG. 1 shown with the backrest in a rear position;

FIG. 4 corresponds to FIG. 3, but shows the piece of seating furniture from the side;

FIG. 5 is an exploded-view drawing of the seating furniture shown in FIGS. 1-4 shown from the side;

FIG. 6 is a perspective exploded-view drawing of the seating furniture shown in FIGS. 1-5; and

FIG. 7 shows the functional unit in the piece of sitting furniture shown in FIGS. 1-6 shown from the side.

### DETAILED DESCRIPTION

In the following description, terms such as “horisontal”, “vertical”, “sideways”, “back and forth”, “up and down”, “upper”, “lower”, “inner”, “outer”, “forward”, “rear” etc. may be used. These terms mainly refer to the perspectives and positions shown in the drawings and which are associated with a normal use of the invention. The terms are only used to make the reading of the description easier and should not be restrictive.

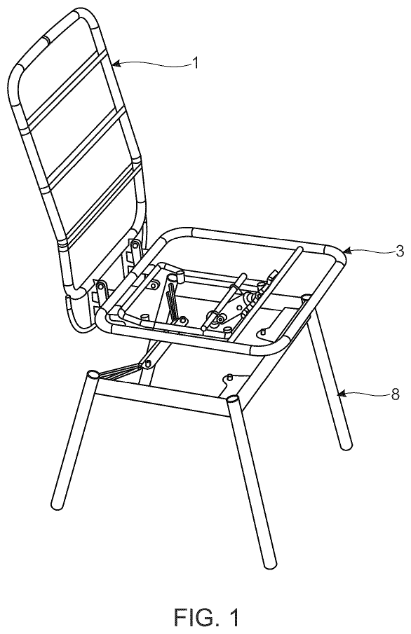

The piece of seating furniture according to the invention comprises three main components: a backrest 1, a seat 3, and a functional unit 12; see, for example, FIG. 1. The backrest and the seat are shown as frame structures that can be adjusted (for example, dressed and upholstered) to the existing type of use of seating furniture in well-known ways. The backrest and seat can also be whole structures, not necessarily frames, manufactured in suitable materials.

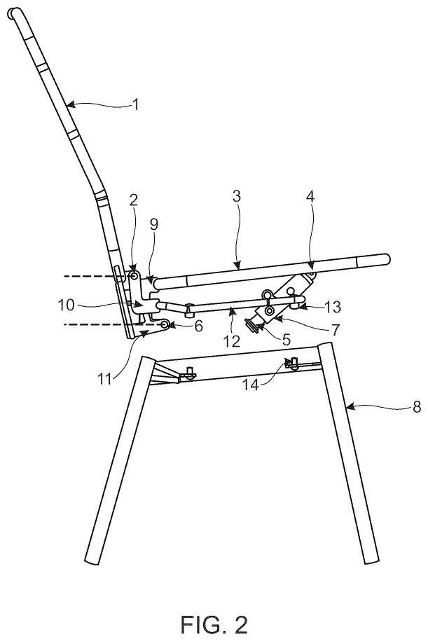

The functional unit 12 is designed and equipped to be attached to a base 8 in a manner known as such, for example, at the attachment points 13 and 14 (see FIG. 2), for example, by screws. In the figures, the base is shown disconnected from the piece of sitting furniture in order to show the mechanisms of the sitting furniture and because the base is not part of the invention. In the illustration examples, the base has four legs. It should be understood that the piece of sitting furniture may be connected to other types of base or foundation.

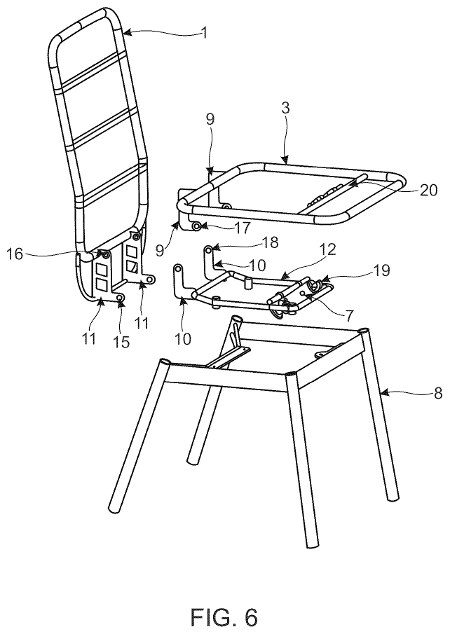

The backrest 1, seat 3, and functional unit 12 are shown separately in FIG. 6. In the illustrated embodiment, the backrest 1 comprises two backresthinge elements 11, which are firmly attached (for example, welded) to a lower part of the backrest, the functional unit 12 comprises two functional hinge elements 10, which are firmly attached (for example, welded) to the functional unit, and the seat 3 comprises two seat hinge elements 9, which are firmly attached (for example, welded) to the seat. The hinge elements 9, 10, 11 may be plate bodies, but not necessarily, and are made from a suitable material. Although the seating furniture in the shown embodiment uses (two) hinge elements 9, 10, 11 of each type, the number of hinge elements shall not be limited to two of each type. Therefore, the three hinge element types will be referred to in singular below.

The backrest hinge element 11 protrudes downwards from a lower part of the backrest, and a lower part of the backrest hinge element extends forward towards the seat 3 and the functional unit 12. This lower part of the backrest hinge element is equipped with a lower bearing part 15. An upper bearing part 16 is located in an upper part of the backrest hinge element 11.

The seat hinge element 9 extends backwards from a rear part of the seat 3 towards the backrest 1, and extends downwards towards the plane of the functional element. A lower part of the seat hinge element 9 is angled and extends forward under a back part of the seat. This lower part of the seat hinge element 9 is equipped with a bearing part 17.

The functional hinge element 10 extends backwards from a rear part of the functional element 12 towards the backrest 2, and is angled in such manner that a distal part of the functional hinge element 10 extends upwards from the functional element 12. This distal part is equipped with a bearing part 18.

The above-mentioned bearing parts 15-18 in the hinge elements 9-11 may, for example, be holes in which a bolt can be inserted (not shown).

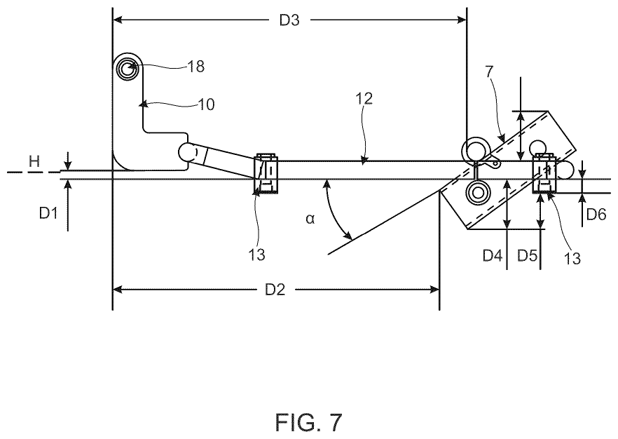

The functional unit 12 comprises a sliding bearing, which comprises a housing (sleeve or the like) 7 firmly attached (for example, welded) to a front part of the functional unit and forms an acute angle α with the main plane H of the functional unit (see FIG. 7). A sliding tube 5 is arranged in the housing 7 (for example, in a plastic lining, not shown) in a sliding manner and has a connection part 19, which is arranged to be rotationally connected to a seat element 20. The seat element 20 is preferably located in a front part of the seat 3, for example, as shown in FIG. 6.

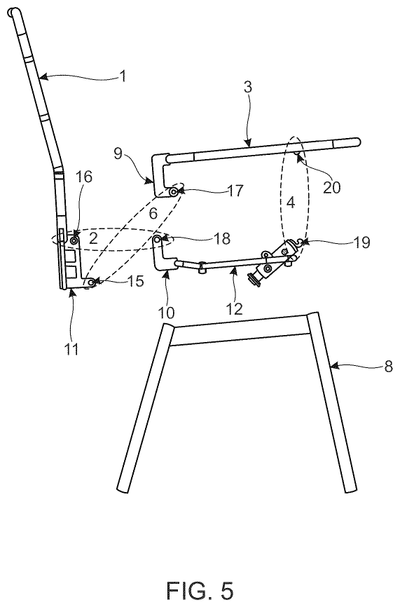

The backrest 1, seat 3, and functional unit 12 are connected as shown in FIG. 5. The functional unit 12 is arranged under the seat 3, and the connection part 19 of the sliding tube is connected to the seat element 20 and forms a front bearing 4. The lower bearing part 15 in the backrest hinge element 11 is rotationally connected to the bearing part 17 in the seat hinge element 9 and forms a first bearing 6. The upper bearing part 16 in the backrest hinge element 11 is rotationally connected to the bearing part 18 in the functional hinge element 10 and forms a second bearing 2. The rotational bearings 2, 4, 6 are indicated in FIG. 5 with dashed lines and can be formed by bolts or other suitable elements.

When the backrest 1 is moved backwards, the backrest 1 is rotated through the second bearing 2 and the seat 3 is led forward and slightly upwards through the first bearing 6. At the same time, the seat 3 moves up and forward by a sliding tube 5 moving in a linear direction to its final stop. When the person sitting on the chair leans forward, all the weight is shifted to the seat 3 and the sliding tube 5 and the seat 3 move down, and at the same time the first bearing 6 goes down and backwards, and the backrest 1 swings forward through the second bearing 2.

The unique position of the first bearing 6 and the second bearing 2 and friction between the sliding tube 5 and the sliding tube housing 7 (and its lining, if any) makes it possible to stop the backrest movement in all positions by increasing or decreasing the pressure on the backrest 1. A spring (not shown) can be placed between the backrest and the seat or functional unit, so that the backrest 1 is always parked in an upright position. The friction between the sliding tube 5 and the sliding tube housing 7 can also be adjusted, for example, by a tightening screw (now shown).

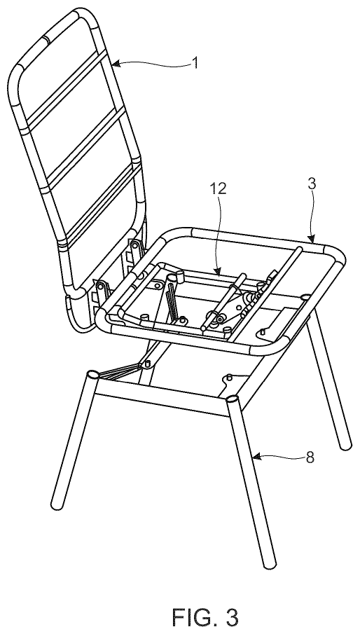

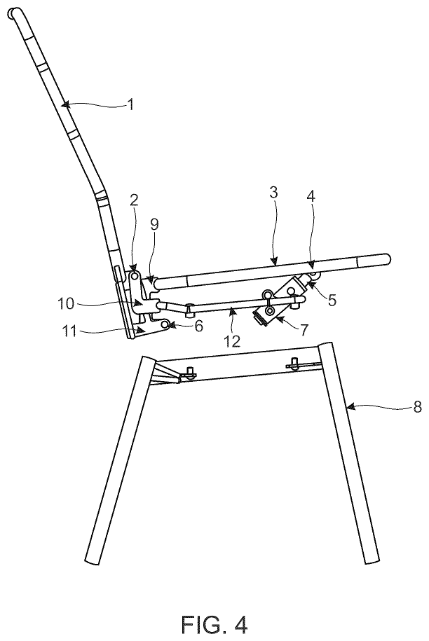

FIGS. 1 and 2 show the backrest 1 in a front position. When the person sitting on the chair leans forward, all the weight is shifted to the seat 3, so that it goes down and presses the backrest 1 back. FIGS. 3 and 4 show the backrest 1 in a rear position. When the backrest is rotated backwards, the seat 3 is moved forward while it rises and changes the sitting angle.

The piece of seating furniture is suitable for small chairs, which are likely to be placed next to a table. The continuous back and forth movement of the backrest and seat by the user moving their body in the chair means that the backrest and seat can be parked in the desired position without using the hands.

An example of the functional unit 12 is shown in FIG. 7 with parameters D1-D6 and α.

1. A piece of sitting furniture comprising:
a backrest;
a seat;
a base; and
a functional unit arranged under the seat and configured to be attached to the base,
wherein each of the backrest, the seat, and the functional unit comprises at least one firmly attached hinge element,
wherein the functional unit comprises a sliding bearing, which includes a housing firmly attached to a front part of the functional unit and forms an acute angle (α) with a main plane (H) of the functional unit,
wherein the piece of sitting furniture further comprises:
a front bearing between the sliding bearing and a seat element of the seat;
a first rotational bearing between the seat and the backrest; and
a second rotational bearing between the functional unit and the backrest, and
wherein the first rotational bearing and the second rotational bearing are arranged at a rear part of the seat, and the first rotational bearing is arranged under the second rotational bearing.

2. The piece of furniture of claim 1,
wherein a hinge element of the at least one firmly attached hinge element of the backrest protrudes downwards from a lower part of the backrest,
wherein a hinge element of the at least one firmly attached hinge element of the seat extends backwards from a rear part of the seat towards the backrest, and
wherein a hinge element of the at least one firmly attached hinge element of the functional unit extends backwards from a rear part of the functional unit towards the backrest.

3. The piece of furniture of claim 1, wherein the front bearing is formed by a rotational connection between a connection part of the sliding bearing and the seat element.

4. The piece of furniture of claim 1,
wherein the first rotational bearing is formed by a rotational coupling between a lower bearing part of a hinge element of the at least one firmly attached hinge element of the backrest and a bearing part of a hinge element of the at least one firmly attached hinge element of the seat, and
wherein the second rotational bearing is formed by a rotational coupling between an upper bearing part of the hinge element of the backrest and a bearing part of the hinge element of the seat.

5. A method of using the piece of seating furniture of claim 1, comprising:
moving the backrest backwards, upon which:
the backrest is rotated through the second bearing,
the seat is led forward and slightly upward through the first bearing, and
at the same time the seat moves up and forward by a sliding tube in the sliding bearing moves in a linear direction to a final stop; and
moving the seat downward, by having a person sitting on the piece of seating furniture leaning forward, and shifting all of a weight of the person to the seat and the sliding tube, and
wherein, at the same time the seat is being moved forward, the first bearing goes downward and backward, and the backrest swings forward through the second bearing.

6. The piece of furniture of claim 3, wherein the seat element is arranged in a front part of the seat.
